(19) United States
(12) Patent Application Publication
(10) Pub. No.: US 2024/0396079 A1
(43) Pub. Date: Nov. 28, 2024

(54) SOLID ELECTROLYTE

(71) Applicant: Arkema France, Colombes (FR)

(72) Inventors: Gérôme GODILLOT, Lacq (FR); Christophe NAVARRO, Lacq (FR); Cécile LUTZ, Lacq (FR); Muriel PLECHOT, Lacq (FR)

(73) Assignee: Arkema France, Colombes (FR)

(21) Appl. No.: 18/697,194

(22) PCT Filed: Sep. 30, 2022
(86) PCT No.: PCT/FR2022/051852

§ 371 Date: Mar. 29, 2024

(30) Foreign Application Priority Data
Oct. 1, 2021 (FR) FR2110398

(51) Int. Cl. H01M 10/056

(52) U.S. Cl. CPC H01M 10/056; H01M 2300/0091

(57) ABSTRACT

The present invention relates to a composition comprising crystals of one or more zeolites, at least one polymeric binder, in an amount between 0.5% and 20% by weight, and at least one ion conductor comprising at least one lithium salt.

The invention also relates to the use of said composition as a battery separator, for example of a secondary battery, more specifically of an all-solid-state battery.

The present patent application relates to the field of electrical energy storage in batteries, more particularly in secondary batteries, and more specifically in secondary batteries of the Li-ion type, notably lithium batteries with a solid electrolyte, also known as all-solid-state batteries.

Research in the field of batteries, notably secondary batteries, and also the developments in this field over the last few decades have been and remain very important, in terms of the number of players and the amounts involved.

Rechargeable, or secondary, batteries are more advantageous than primary (non-rechargeable) batteries since the associated chemical reactions taking place at the positive and negative electrodes of the battery are reversible. The electrodes of secondary cells can be regenerated several times by applying an electrical charge. This is why many electrode systems have been developed for storing electrical charge. In parallel, extensive efforts have been devoted to developing electrolytes that are capable of improving the capacities of electrochemical cells.

Typically, a battery comprises at least one negative electrode (or anode) coupled to a copper current collector, a positive electrode (or cathode) coupled to an aluminium current collector, a separator and an electrolyte. The electrolyte consists, for example, of a lithium salt, which is generally lithium hexafluorophosphate in the case of Li-ion batteries, mixed with a solvent which is generally a mixture of organic carbonates, chosen to optimize ion transport and dissociation. A high dielectric constant favours ion dissociation, and thus the number of ions available in a given volume, whereas a low viscosity favours ion diffusion, which plays a key role, among other parameters, in the charging and discharging rates of the electrochemical system.

Typical Li-ion batteries thus comprise liquid electrolytes, which are notably and most often based on solvent(s), lithium salt(s) and additive(s). Given the increasing use of batteries of this type in the field of common electronic consumer products such as computers, tablets or mobile phones (smartphones), but also in the field of transportation notably with electric vehicles, improving the safety and reducing the manufacturing cost of these lithium batteries have become major challenges.

Specifically, liquid electrolytes offer the advantage of good ion conductivity, but have the drawback of allowing fluids to escape (leaks) in the event of mechanical and/or chemical damage to the battery. Leaks are harmful because they usually lead to malfunction or even failure of the battery, but also and above all to pollution and degradations by corrosion or even ignition and/or explosion of the battery.

To solve this problem, and in replacement for flammable liquid electrolytes, “all-solid-state” batteries comprising solid polymer electrolytes, representatives of which are SPEs (the abbreviation for Solid Polymer Electrolytes), have been studied in recent years. Solid polymer electrolytes, SPEs, without liquid solvent, thus avoid the use of flammable liquid components as in conventional Li-ion batteries and allow the production of thinner and more flexible batteries.

Besides SPEs, other types of all-solid-state batteries are batteries that are mainly composed of oxides or phosphates. These all-solid-state batteries have shown great potential both for small-sized applications, such as three-dimensional microbatteries, for example, and for large-scale energy storage applications, such as for electric vehicles.

Moreover, and in order to offer the expected performance, the ion conductivity of the solid electrolytes present in such all-solid-state batteries must be at least equivalent to that of liquid electrolytes, i.e. of the order of 10⁻³ S·cm⁻¹ at 25° C. as measured by electrochemical impedance spectroscopy. The electrochemical stability must allow the use of the electrolyte with cathode materials that can function at high voltage, notably at voltages above 4.4 V, in fields where high energy densities are required, as is the case, for example, for the motor vehicle industry. Finally, the solid electrolyte must have a certain resistance to fire or battery runaway, i.e. it must be able to function without any major problems at least up to 80° C. and not ignite below 130° C.

Thus, solid electrolytes have been and continue to be the subject of intensive research to overcome the drawbacks listed above. Inorganic materials, such as oxides, phosphates and ceramics, have conductivities of up to 10⁻³ S·cm⁻¹ at 25° C. (the order of magnitude of conductivity of liquid electrolytes), but are very rigid, or even brittle. As a result, they do not cope well with the volume changes to which electrodes are subject during cycling, which can lead to a loss of contact between electrode and solid electrolyte.

Other inorganic materials, thiophosphates (cf. ACS Energy Lett., (2020), 5 (10), 3221-3223), offer better conductivities (up to 10⁻² S·cm⁻¹ at 25° C.), which can exceed those of liquid electrolytes. However, thiophosphates are also relatively rigid, have low electrochemical stability windows, but above all are very unstable with respect to water and release hydrogen sulfide (H₂S) in the event of accidental opening of the cell, which is unacceptable, for obvious reasons of environmental protection but also and above all in terms of user safety.

Another solution envisaged is the use of polymers, which, due to their high flexibility, are the most likely to cope with variations in electrode volumes during cycling, and to avoid the risk of fracturing at the electrode/electrolyte interface. However, in certain cases, polymers suffer from somewhat limited electrochemical stability, and above all from low conductivity, which is often less than 10⁻⁴ S·cm⁻¹ at 25° C.

In order to overcome this low ion conductivity at room temperature, but also to further improve the mechanical properties, it has been proposed (cf. L. Z. Fan, H. He, C. W. Nan, “Tailoring inorganic-polymer composites for the mass production of solid-state batteries”, Nat. Rev. Mater., (2021), https://doi.org/10.1038/s41578-021-00320-0) to add materials of mineral filler type, for example zeolites. The term “active filler” is used if said filler is a lithium ion conductor (for example LATP—Lithium Aluminium Titanium Phosphate, LLZO—Lithium Lanthanum Zirconium Oxide, lithium zeolites, etc.) and an “inactive filler” if it is not an ion conductor (SiO₂, Al₂O₃, etc.). A solid electrolyte consisting of a polymer/mineral filler composite is called a hybrid solid electrolyte.

At the present time, the polymers most commonly used as solid polymer electrolytes are polyethers, for instance poly(ethylene oxide), also known as PEO. However, these polymers have the drawback of crystallizing readily, especially at temperatures close to room temperature, which has the effect of very significantly reducing the ion conductivity of the polymer. This is why these polymers allow the use of the battery into which they are inserted only at a minimum temperature above their glass transition temperature, for example above 60° C. However, it would be convenient to be able to use such a battery at room temperature and even at negative temperatures, typically −20° C. or even lower. Furthermore, these PEOs are highly hydrophilic and have a tendency to plasticize, especially in the presence of lithium salts, which reduces their mechanical stability. Finally, the poly(ethylene oxide) monomer is known to be lethal by inhalation, making the use of this product hazardous to health.

The polymer electrolyte ensures mechanical stability during the charging/discharging cycles of the battery, making it possible to conserve the cohesion between the electrolyte and the electrodes and to ensure electrical insulation between the two electrodes during the volume variations associated with the insertion/deinsertion of lithium, without compromising the ion conductivity with excessively long chains. Hitherto, to solve this size stability problem, notably with PEOs, it was necessary to produce polymers bearing very long chains to obtain an entanglement of chains and to ensure the mechanical stability of the electrode. However, this increase in the molecular mass of the polymer takes place to the detriment of the mobility of its chains, its glass transition temperature and its ion conductivity.

Consequently, to obtain a polymer that is a good ion conductor, even at room temperature or at low temperature, typically at a temperature of between −20° C. and +80° C., in order to obtain a highly efficient battery, it is first necessary to minimize its degree of crystallinity, so that it cannot crystallize at the operating temperature of the battery and impair the ion conductivity, and it is secondly necessary for it to have a glass transition temperature that is as low as possible and below the operating temperature of the battery so that it does not have a glassy state, at the operating temperature of the battery, which is itself also liable to weaken the ion conductivity.

As indicated above, another component of the conventional Li-ion battery (with a liquid electrolyte) is the separator, located between the two electrodes, which acts firstly as a mechanical and electronic barrier and secondly as an ion conductor. Several categories of separators exist, which can be referred to by the generic terms: dry polymer membranes, gelled polymer membranes and microporous or macroporous separators soaked with liquid electrolyte.

The separator market is currently dominated by the use of polyolefins (for example those sold by Celgard, Asahi Kasei, Toray, Sumitomo Chemical and SK Innovation to name but the most common), generally produced by extrusion and/or drawing. Separators must simultaneously have low thicknesses, optimum affinity for the electrolyte and sufficient mechanical strength. Among the most advantageous alternatives to polyolefins, polymers which have better affinity towards standard electrolytes have been proposed, in order to reduce the internal resistances of the system, such as poly(vinylidene fluoride) (PVDF) and poly(vinylidene fluoride-hexafluoropropene) (P(VDF-co-HFP)).

Dry polymer membranes, free of liquid solvent, avoid the use of flammable liquid components as in conventional Li-ion batteries and allow the production of thinner and more flexible batteries. However, they have properties that are markedly inferior to those of liquid electrolytes, notably as regards ion conductivity. Good conductivity is required for functioning at high regime, for example for mobile phones, for fast charging, notably for electric vehicles, or for power applications, for example for power tools.

Gelled dense membranes also constitute an alternative to separators soaked with liquid electrolyte. The term “dense membranes” refers to membranes which no longer have any free porosity. They are swollen with the solvent but said solvent, strongly chemically bonded to the membrane material, has lost all its solvating properties. The solute then passes through the membrane without entraining any solvent. In the case of these membranes, the free spaces correspond to those left between them by the polymer chains and have the size of simple organic molecules or hydrated ions. The major drawback of these gelled membranes is that they contain large amounts of flammable solvents. Another drawback that may be mentioned is that they lose their mechanical properties after swelling, which impairs easy handling of the separator for cell manufacture and good resistance to mechanical stresses during the charging/discharging cycles of the battery.

U.S. Pat. No. 5,296,318 describes separators based on VDF-HFP copolymers swollen in an electrolyte consisting of a lithium salt (LiPF₆) and of a mixture of carbonates as solvent. The examples described use Kynar Flex® 2801 and Kynar Flex® 2750 containing 12% and 15% by weight of HFP, respectively. More generally, said patent describes an optimum HFP content of between 8% and 25% by weight of HFP. Below 8% of HFP, the authors mention difficulties associated with the use of the membrane. Above 25%, the mechanical strength becomes insufficient after swelling. The process for manufacturing the separator is a solvent-based process which involves the use of a very volatile solvent, tetrahydrofuran. The ion conductivities reported in Examples 1 and 2 are 0.3 mS·cm⁻¹ and 0.4 mS·cm⁻¹, respectively.

Said document describes the need to use an additional crosslinking step, for separators based on VDF-HFP copolymer having an HFP content of greater than 25% by weight, in order to reinforce their mechanical strength after swelling. These copolymers give satisfactory results even after heating up to 70° C. However, the copolymer swollen under the effect of the solvent is soluble in the liquid electrolyte at temperatures above 80° C. Melting of the electrolyte film under constant stress can cause the electrolyte to flow and the battery to short circuit internally, resulting in rapid discharging and heating.

In order to solve this problem, US 2019/0088916 proposes a non-porous separator containing macromolecular materials which can be gelled with an organic solvent in the electrolyte solution, and which form a polymer gel electrolyte upon addition of the electrolyte solution. This non-porous separator comprises at least one synthetic macromolecular compound or one natural macromolecular compound, and also comprises, as matrix, at least one macromolecular material which cannot be gelled with an organic solvent. The examples show that the non-gellable polymer is used in the form of a porous membrane which is impregnated with a solution of the gellable polymer. This approach thus imposes a complex step for manufacturing the porous membrane of the non-gellable polymer, which makes it possible to control the degree of porosity and the nature of the porosity (pore size and degree of open porosity). Furthermore, the manufacturing process requires the use of a solvent-based step to impregnate the porosities of the porous membrane, which has the drawback of using solvents and requires an evaporation step.

International patent application WO 2020/0127454 relates to the aqueous dispersion polymerization of monomers containing VF2 using RAFT/MADIX technology. More particularly, said document describes a composition containing a non-electroactive mineral filler which may be a zeolite or silica, to make a separator after a step of drying of the dispersion.

The studies by X. Chi et al. (Nature, Vol. 592, (2021), 551-571) propose, in the context of batteries based on Li-air technology, a continuous membrane obtained by grafting carbon nanotubes (CNTs) onto a steel mesh, followed by seeded growth of LiX zeolite on the CNTs. The zeolite is preferentially generated in situ by crystal growth directly on the CNTs. It is thus a hybrid system combining steel, carbon nanotubes and zeolites, the production of which on an industrial scale seems relatively difficult and thus expensive. In addition, the mechanical strength of this hybrid system may prove to be insufficient or even inadequate considering that cracks could lead to lithium dendrites which can cause short circuits in the battery.

Other documents in the scientific and patent literature describe the presence of zeolites in Li-ion batteries, for example as a component of the separator, usually as an adsorbent of unwanted molecules, such as water or acids, but also as a coating agent on the separator itself, in order to reinforce its mechanical properties. In this configuration, it is thus a porous separator for lithium-ion batteries with a liquid or gel electrolyte consisting of a film of porous polymer (for example polypropylene) with a surface layer of zeolite, the adhesion between the porous polymer and the zeolite generally being ensured by another polymer, for example PVDF.

U.S. Pat. No. 5,728,489 describes a liquid electrolyte comprising a polymer matrix whose structural integrity can be reinforced with a lithiated zeolite present in an amount of between 1% and 30% by weight of the liquid electrolyte. As indicated above, liquid electrolyte batteries are unsatisfactory in that they may be subject to leakage of said liquid electrolyte.

CN104277423 describes a material for reducing the operating temperature of batteries, said material being heat-conducting and fire retardant and comprising a mixture of mineral fillers, including a small proportion of zeolites, said mixture being subjected to sintering with a ceramic filler. CN201210209283 describes a solid electrolyte comprising a polyoxyethylene or a derivative thereof, a lithium salt, and an organic/mineral hybrid framework chosen from a metal/organic framework (MOF), a covalent/organic framework (COF), and a zeolite/imidazole framework (ZIF).

There is thus still a need for all-solid-state batteries which do not have the drawbacks known today and recalled previously.

Thus, a first object of the present invention is to propose a solid electrolyte for the production of all-solid-state batteries not having the risk of leakage in the event of mechanical damage of the battery. As a further subject, the invention proposes a solid electrolyte for the production of electrodes with satisfactory mechanical stability, and more particularly satisfactory size stability, so as to avoid loss of cohesion and loss of adhesion to the metallic current collector.

Another object of the invention is to propose a solid electrolyte with satisfactory conductivity even at low temperatures, typically below 80° C. and which may be down to −20° C. or even −30° C., and notably with a conductivity equivalent to or even higher than that of liquid electrolytes, for example of the order of 10⁻³ S·cm⁻¹. Yet another object is to propose a solid electrolyte with high chemical stability under voltage (electrochemical stability), typically greater than or equal to 4.4 V.

Another object of the invention is to propose a process for producing a solid electrolyte, which is quick, easy and inexpensive to perform, making it possible to avoid the formation of dendrites, which is anhydrous to set aside any risk of degradation, and which allows the production of a system with the least possible amount of volatile compounds so as to set aside any risk of ignition. Another object is to propose a solid electrolyte with good fire resistance, notably with limited or even no risk of ignition at temperatures below 120° C. Another object is to propose a solid electrolyte with good resistance to runaway and notably maintenance of the electrical properties, and in particular the conductivity properties, under the operating conditions, for example up to temperatures of about 80° C. Yet other objects will become apparent in the light of the description of the present invention which is now presented below.

Thus, the present invention relates to the field of electrochemical devices, in particular lithium-ion batteries, and more particularly all-solid-state lithium batteries. More particularly, the invention relates to a solid electrolyte composition for use in such a battery, notably in the separator, and/or in the cathode (catholyte), and/or in the anode (anolyte). The invention also relates to a process for manufacturing such a composition, notably intended for the production of an all-solid-state lithium battery. More particularly, this composition is intended for the manufacture of the separator of such a battery. The invention also relates to a battery separator comprising such a solid electrolyte composition and to processes for manufacturing same.

The inventors have now discovered that it is possible to achieve at least some, if not all, of the abovementioned objects by means of the invention which is detailed below and which notably makes it possible to combine both the advantages of a liquid electrolyte in terms of conductivity, and those afforded by a solid electrolyte notably in terms of stability and absence of risk of leakage.

Thus, and according to a first aspect, the present invention relates to a composition comprising:
A/ crystals of one or more zeolites,
B/ at least one polymeric binder, the amount of said polymeric binder being between 0.5% and 20% by weight, preferably between 1% and 10% by weight, relative to the total weight of the zeolite crystals and of the binder, and
C/ at least one ion conductor comprising at least one lithium salt.

Unless otherwise indicated in the present disclosure, the ranges of values are understood to be inclusive of the limits.

Thus, the invention relates to a solid electrolyte which combines zeolite crystals immobilized with a polymeric binder, thus providing cohesion to the solid electrolyte and also mechanical strength and flexibility which are entirely suitable for use in a battery. In addition, the zeolite crystals bound by the polymeric binder act as reservoirs for the ion conductor and thus ensure an electrical conductivity that is entirely suitable for use in a battery, notably a secondary battery. In other words, the ion conductor of the composition according to the invention is contained in the solid combination of zeolite crystals+polymeric binder (interior and surface).

In the solid electrolytes of the prior art, when zeolites are present, they are used to trap undesirable elements, such as water (moisture), rather than to form a solid three-dimensional network that is capable of retaining the ion conductor. In addition, in the prior art, the proportion of zeolite is always low, or even very low, in the solid electrolyte.

The zeolite crystals that can be used in the present invention may be crystals of one or more identical or different zeolites. The term “zeolite” means a particular negatively charged ceramic with an aluminosilicate backbone, the electrical neutrality of which is ensured by one or more counter-cations.

Examples of zeolite crystals that are entirely suitable for use in the present invention include crystals of one or more zeolites chosen from natural or synthetic zeolites, and more particularly natural zeolites. More specifically, the zeolites are chosen from faujasites (FAU), MFI zeolites, chabazites (CHA), heulandites (HEU), Linde type A (LTA) zeolites, EMT zeolites, beta zeolites (BEA), mordenites (MOR) and mixtures thereof. These various types of zeolites are clearly defined, for example in the “Atlas of Zeolite Framework Types”, 5th edition, (2001), Elsevier, and are readily commercially available to those skilled in the art or readily synthesized by means of known procedures available in the scientific literature and in the patent literature.

For the purposes of the present invention, it is also possible to use hierarchically porous homologues of the abovementioned zeolites (known as “HPZs”) which are generally obtained by direct synthesis, notably using sacrificial agents, as described, for example, in patent applications WO 2015/019013 or WO 2007/043731, or by post-treatment, as described, for example, in WO 2013/106816.

Preferably, the zeolite crystals are crystals of one or more zeolites chosen from faujasite, and preferably type Y, X, MSX or LSX faujasite, and entirely preferably type X, MSX or LSX faujasite, more preferably type MSX or LSX faujasite and entirely preferably type LSX faujasite. These various types of faujasites are characterized by their silicon/aluminium (Si/Al) mole ratio, which is well known to those skilled in the art and which can be measured according to the indications given in the characterization techniques described later in the present description. LSX type faujasites are characterized by an Si/Al mole ratio equal to about 1.00±0.05. MSX type faujasites are characterized by an Si/Al mole ratio of between 1.05 and 1.15, X type faujasites are characterized by an Si/Al mole ratio of between 1.15 and 1.50, and Y type faujasites are characterized by an Si/Al mole ratio of greater than 1.50. For reasons of homogeneity, it is preferable to use only one type of zeolite, and preferably only one type of zeolite which is a faujasite-type zeolite.

The counter-cation used to neutralize the zeolite may be any cation that is well known to those skilled in the art and for example a cation chosen from the hydronium ion, organic cations (such as imidazolium, pyridinium, pyrrolidinium, and others), alkali metal cations, alkaline-earth metal cations, transition metal cations, rare-earth metal cations, in particular the lanthanum cation, the praseodymium cation, the neodymium cation, and also mixtures of two or more of the cations listed above. For the purposes of the present invention, when the solid electrolyte is particularly suitable for the preparation of lithium-ion batteries, the preferred zeolites are those in which the counter-cation is the lithium cation, optionally with the hydronium cation and/or one or more other alkali metal or alkaline-earth metal cations, for example sodium, potassium, rubidium, caesium, magnesium, calcium, strontium or barium cations, and mixtures thereof, said cations preferably being in negligible amounts relative to the lithium cation, for example less than 5% of the exchangeable sites according to the indications given in the characterization techniques described below.

According to a preferred aspect of the present invention, the counter-cation of the zeolite is lithium, in an amount of greater than 95%, preferably greater than 98%, more preferably greater than 99%, of the exchangeable sites, as indicated below, the other counter-cations necessary for the neutrality of the zeolite advantageously include alkali metal and alkaline-earth metal cations, rare-earth metal cations, and transition metal cations, such as titanium, zirconium, hafnium, rutherfordium, and the hydronium cation, and also mixtures of the abovementioned cations.

According to a most particularly advantageous aspect, the composition of the present invention comprises an LSX-type faujasite zeolite, the counter-cation of which is lithium in an amount of greater than 95% of the exchangeable sites, this zeolite being commonly designated “LiLSX”.

The size and granulometry of the zeolite crystals present in the composition according to the invention may vary within wide proportions. However, it is preferred for the size of the crystals, evaluated by scanning electron microscope (SEM) observation as indicated later in the characterization techniques, to be between 0.02 μm and 20.00 μm, more preferably between 0.02 μm and 10.00 μm, more preferably between 0.03 μm and 5.00 μm, and advantageously between 0.05 μm and 1.00 μm. According to a most particularly preferred aspect, the particle size distribution of crystal sizes is unimodal, bimodal or multimodal, preferably bimodal.

The composition according to the invention is a solid composition, and is advantageously anhydrous, i.e. it does not include any water, or else has only traces of water, i.e. an amount of water of less than 1000 ppm, preferably less than 100 ppm, better still less than 50 ppm by volume.

In the composition according to the present invention, which is a solid composition, the polymeric binder ensures the cohesion of the zeolite crystals. The polymeric binder is very advantageously electrochemically stable, i.e. it is not degraded or otherwise deteriorated under electrical voltage, and as such the physical integrity and electrochemical properties of the battery components are preserved, notably when it is subjected to the operating temperatures and electrical voltages of the battery, typically in the range from −20° C. to +80° C., and an electrical voltage of greater than 4.4 V. Examples of polymers that are best suited to the purposes of the present invention include, but are not limited to, fluoropolymers (PVDF, PTFE), carboxymethylcelluloses (CMC), styrene-butadiene rubbers (SBR), polyacrylic acids (PAA) and esters thereof, polyimides, and the like, preferably fluoropolymers, including optionally functionalized fluorinated homopolymers and optionally functionalized fluorinated copolymers.

Among the fluoropolymers, poly(vinylidene fluoride), better known by the abbreviation PVDF, is preferred. Also preferred are copolymers of vinylidene fluoride (VDF) with at least one VDF-compatible comonomer. The term “VDF-compatible comonomer” means a comonomer which may be halogenated (fluorinated and/or chlorinated and/or brominated) or non-halogenated, and which is polymerizable with VDF.

Non-limiting examples of suitable comonomers comprise vinyl fluoride, 1,2-difluoroethylene, trifluoroethylene, tetrafluoroethylene, hexafluoropropylene, trifluoropropenes and notably 3,3,3-trifluoropropene, tetrafluoropropenes and notably 2,3,3,3-tetrafluoropropene or 1,3,3,3-tetrafluoropropene, hexafluoroisobutylene, perfluorobutylethylene, pentafluoropropenes and notably 1,1,3,3,3-pentafluoropropene or 1,2,3,3,3-pentafluoropropene, perfluorinated alkyl vinyl ethers and notably those of general formula Rf—O—CF═CF₂, Rf being an alkyl group, preferably including from 1 to 4 carbon atoms (preferred examples being perfluoropropyl vinyl ether and perfluoromethyl vinyl ether). The comonomers may include, in addition to fluorine, one or more chlorine and/or comonomers may be chosen in particular from bromine atoms. Such bromotrifluoroethylene, chlorofluoroethylene, chlorotrifluoroethylene and chlorotrifluoropropene. Chlorofluoroethylene can denote either 1-chloro-1-fluoroethylene or 1-chloro-2-fluoroethylene. The 1-chloro-1-fluoroethylene isomer is preferred. The chlorotrifluoropropene is preferably chosen from 1-chloro-3,3,3-trifluoropropene and 2-chloro-3,3,3-trifluoropropene, and mixtures thereof.

According to a preferred embodiment, the comonomers are chosen from vinyl fluoride, trifluoroethylene, chlorotrifluoroethylene (CTFE), 1,2-difluoroethylene, tetrafluoroethylene (TFE) hexafluoropropylene (HFP), perfluoro (alkyl vinyl) ethers such as perfluoro(methyl vinyl) ether (PMVE), perfluoro (ethyl vinyl) ether (PEVE), perfluoro (propyl vinyl) ether (PPVE) and mixtures thereof.

According to one embodiment, the VDF copolymer is a terpolymer. According to one embodiment, the polymeric binder is a copolymer of vinylidene fluoride (VDF) and hexafluoropropylene (HFP), more commonly known as P(VDF-co-HFP). Advantageously, said P(VDF-co-HFP) copolymer has a mass content of HFP of greater than or equal to 5% and less than or equal to 45%.

According to a preferred aspect of the present invention, the polymeric binder is not soluble in the ion conductor. According to another preferred aspect, the polymeric binder is a fluoropolymer and preferably the polymer is chosen from optionally functionalized PVDF, and optionally functionalized PVDF-based copolymers. It is clearly understood that two or more different polymeric binders may be used in the composition of the present invention.

The polymeric binder, used in minimal proportion relative to the amount of zeolite crystals, as indicated previously, allows cohesion between said zeolite crystals which behave like a solid reservoir for the ion conductor of the composition of the invention. The mass amount of zeolite crystals present in the composition according to the present invention can be measured by thermogravimetric analysis (TGA) in air, between 25° C. and 450° C., with a heating rate of +5° C.·min⁻¹.

The ion conductor present in the composition according to the present invention is preferably and very advantageously anhydrous, i.e. it does not contain any water or contains only traces of water, i.e. an amount of water of less than 1000 ppm, preferably less than 100 ppm, better still less than 50 ppm by volume.

According to one embodiment, the ion conductor comprises and preferably consists of at least one lithium salt. The lithium salt that may be used in the context of the present invention is preferably chosen from lithium bis(fluorosulfonyl)imide (LiFSI), lithium bis(trifluoromethanesulfonyl)imide) (LiTFSI), lithium 2-trifluoromethyl-4,5-dicyanoimidazole (LiTDI), lithium hexafluorophosphate (LiPF₆), lithium tetrafluoroborate (LiBF₄), lithium nitrate (LiNO₃), lithium bis(oxalato) borate (LiBOB), and also mixtures of two or more thereof, in any proportions. A lithium salt that is particularly preferred for the purposes of the invention is the LiTFSI sold by Solvay or the LiFSI and/or LiTDI sold by the company Arkema. LiFSI is most particularly preferred, optionally as a mixture with LiTDI from Arkema.

When it is present, the solvent used is a solvent for the lithium salt. Among the solvents that are entirely suitable, mention may be made of ionic liquids, in particular ionic liquids formed by the combination of an organic cation and an anion.

As non-limiting examples of organic cations, mention may be made of ammonium, sulfonium, pyridinium, pyrrolidinium, imidazolium, imidazolinium, phosphonium, guanidinium, piperidinium, thiazolium, triazolium, oxazolium and pyrazolium cations and mixtures thereof. According to one embodiment, this cation may comprise a C1-C30 alkyl group, for instance 1-butyl-1-methylpyrrolidinium (BMPYR), 1-ethyl-3-methylimidazolium (EMIM), tributylmethylphosphonium (TBMPHO), N-methyl-N-propylpyrrolydinium or N-methyl-N-butylpiperdinium.

According to one embodiment, the anions that are associated therewith are chosen, as non-limiting examples, from imides, notably bis(fluorosulfonyl)imide and bis(trifluoromethanesulfonyl)imide, borates, phosphates phosphinates and phosphonates, notably alkyl phosphonates, amides (notably dicyanamide), aluminates (notably tetrachloroaluminate), halides (such as bromide, chloride and iodide anions), cyanates and acetates (CH₃COO⁻) and notably trifluoroacetate (CF₃COO⁻), sulfonates and notably methanesulfonate (CH₃SO₃⁻) or trifluoromethanesulfonate (CF₃SO₃⁻), and sulfates, notably hydrogen sulfate.

According to a preferred embodiment, the anions are chosen from tetrafluoroborate (BF₄⁻), bis(oxalato) borate (BOB), hexafluorophosphate (PF₆⁻), hexafluoroarsenate (AsF₆⁻), triflate or trifluoromethylsulfonate (CF₃SO₃⁻), bis(fluorosulfonyl)imide (FSI⁻), bis(trifluoromethanesulfonyl)imide (TFSI⁻), nitrate (NO₃⁻) and 4,5-dicyano-2-(trifluoromethyl) imidazole (TDI⁻). According to one embodiment, said anion is chosen from TDI⁻, FSI⁻, TFSI⁻, PF₆⁻, BF₄⁻, NO₃⁻ and BOB⁻, and preferably said anion is FSI⁻.

Among the preferred ionic liquids, non-limiting examples that may be mentioned include EMIM-FSI, EMIM-TFSI, BMPYR-FSI, BMPYR-TFSI, TBMPHO-FSI, TBMPHO-TFSI and mixtures thereof.

As other possible solvent(s), mention may be made, in a non-limiting manner, of:
carbonates, such as vinylene carbonate (VC) (CAS: 872-36-6), fluoroethylene carbonate or 4-fluoro-1,3-dioxolan-2-one (F1EC) (CAS: 114435 February 8), trans-4,5-difluoro-1,3-dioxolan-2-one (F2EC) (CAS: 171730-81-7), ethylene carbonate (EC) (CAS: 96-49-1), propylene carbonate (PC) (CAS: 108-32-7),
nitriles, such as succinonitrile (SN), 3-methoxypropionitrile (CAS: 110-67-8), (2-cyanoethyl)triethoxysilane (CAS: 919-31-3),
ethers, such as 1,3-dioxolane (DOL), dimethoxyethane (DME), dibutyl ether (DBE), poly(ethylene glycol dimethyl ether) s, notably diethylene glycol dimethyl ether (EG2DME), triethylene glycol dimethyl ether (EG3DME), and tetraethylene glycol dimethyl ether (EG4DME),
sulfolane (CAS: 126-33-0), and
triethyl phosphate (TEP) (CAS: 78-40-0).

Among the solvents listed above, EG4DME, DOL, DME, SN and F1EC are preferred. Mixtures of two or more of the solvents defined previously may be used, optionally in combination with one or more ionic liquids as defined previously. The amount of solvent(s) may vary within wide proportions, for example in the range from 1% to 99% by weight.

Thus, non-limiting and purely illustrative examples of ion conductors include LiFSI, LiTFSI, or a mixture of LiFSI and LiTFSI, in combination with one or more solvents advantageously chosen from SN, DOL, DME, F1EC and EG4DME, optionally with one or more ionic liquids, for example EMIM-FSI or TBMPHO-FSI.

More particularly preferred examples include mixtures as follows: (LiFSI and SN), (LiTFSI and SN), (LiFSI and TEP), (LiFSI and EG4DME), (LIFSI, EC and F1EC), (LIFSI, EG4DME and EMIM-FSI), (LIFSI, EG4DME and TBMPHO-FSI), (LIFSI, EC, F1EC and EMIM-FSI), (LIFSI, DOL and DME), and (LIFSI, DOL, DME and SN).

Examples of ion conductors that are entirely suitable for the purposes of the present invention include:
LiFSI (14% by weight) and succinonitrile (86% by weight),
LiTFSI (20% by weight) and succinonitrile (80% by weight),
LiFSI (14% by weight) and TEP (86% by weight),
LiFSI (14% by weight) and EG4DME (86% by weight),
LiFSI (14% by weight), EC (80% by weight) and F1EC (6% by weight),
LiFSI (14% by weight), EG4DME (43% by weight) and EMIM-FSI (43% by weight),
LiFSI (14% by weight), EG4DME (43% by weight) and TBMPHO-FSI (43% by weight),
LiFSI (14% by weight), EC (37% by weight), F1EC (6% by weight) and EMIM-FSI (43% by weight),
LiFSI (14% by weight), DOL (43% by weight) and DME (43% by weight),
LiFSI (14% by weight), DOL (21.5% by weight), DME (21.5% by weight) and SN (43% by weight).

As indicated below, the ion conductor is soaked into the solid (zeolite crystals+polymeric binder). The amount of ion conductor that can be impregnated into said solid may vary within wide proportions and notably, without being limiting, according to the nature of the zeolite and the size of the zeolite crystals, the zeolite/binder weight ratio, the nature and amount of each of the components of the ion conductor, inter alia. This amount is generally between 5% and 400%, preferably between 5% and 300%, more preferably between 10% and 200%, by weight relative to the solid (zeolite crystals+polymeric binder(s)).

The composition according to the invention is thus a solid electrolyte characterized by the presence of a (liquid) ion conductor which impregnates a set of crystals of one or more zeolites which are integrally attached together by means of at least one polymeric binder. According to one embodiment of the present invention, the amount of crystals of one or more zeolites represents at least 55%, preferably at least 60%, more preferably at least 80%, advantageously at least 90% and more preferentially at least 95% by weight, of the solid (zeolite+binder), not counting the ion conductor.

Non-limiting examples of compositions according to the present invention are compositions comprising:
A/ crystals of FAU-type zeolite(s), advantageously crystals of LSX zeolite preferably exchanged with lithium,
B/ at least one fluorinated polymeric binder, preferably PVDF, in an amount of between 0.5% and 20% by weight, preferably between 1% and 10% by weight, relative to the total weight of the crystals of one or more zeolites and the binder, and
C/ at least one ion conductor comprising at least one lithium salt, advantageously LiFSI, at least one solvent advantageously chosen from SN, DOL, DME, F1EC and EG4DME, optionally with at least one ionic liquid, for example EMIM-FSI.

As non-limiting examples of compositions according to the present invention, mention may be made of:
Zeolite LiLSX (45% by weight), PVDF (5% by weight) and ion conductor [50% by weight, composed of LiFSI (14% by weight) and succinonitrile (86% by weight)],
LiLSX zeolite (58.5% by weight), PVDF (6.5% by weight) and ion conductor [35% by weight, composed of LiFSI (14% by weight) and succinonitrile (86% by weight)],
LiLSX zeolite (61.7% by weight), PVDF (3.3% by weight) and ion conductor [35% by weight, composed of LiFSI (14% by weight) and succinonitrile (86% by weight)],
LiLSX zeolite (61.7% by weight), PVDF (3.3% by weight) and ion conductor [35% by weight, composed of LiTFSI (20% by weight) and succinonitrile (80% by weight)],
LiLSX zeolite (61.7% by weight), PVDF (3.3% by weight) and ion conductor [35% by weight, composed of LiFSI (14% by weight) and TEP (86% by weight)],
LiLSX zeolite (61.7% by weight), PVDF (3.3% by weight) and ion conductor [35% by weight, composed of LiFSI (14% by weight) and EG4DME (86% by weight)],
LiLSX zeolite (61.7% by weight), PVDF (3.3% by weight) and ion conductor [35% by weight, composed of LiFSI (14% by weight), EC (80% by weight) and F1EC (6% by weight)],
LiLSX zeolite (61.7% by weight), PVDF (3.3% by weight) and ion conductor [35% by weight, composed of LiFSI (14% by weight), EMIM-FSI (43% by weight) and EG4DME (43% by weight)],
LiLSX zeolite (61.7% by weight), PVDF (3.3% by weight) and ion conductor [35% by weight, composed of LiFSI (14% by weight), TBMPHO-FSI (43% by weight) and EG4DME (43% by weight)],
LiLSX zeolite (61.7% by weight), PVDF (3.3% by weight) and ion conductor [35% by weight, composed of LiFSI (14% by weight), EMIM-FSI (43% by weight), EC (37% by weight) and F1EC (6% by weight)],
Zeolite LiLSX (61.7% by weight), PVDF (3.3% by weight) and ion conductor [35% by weight, composed of LiFSI (14% by weight), DOL (21.5% by weight), DME (21.5% by weight) and SN (43% by weight)].

The composition of the present invention has the advantage of being a solid electrolyte while at the same time having good flexibility, and providing mechanical strength that is entirely suitable for use in batteries, particularly lithium-ion batteries. It was discovered, entirely surprisingly, that the conductivities of the compositions of the present invention are of the same order of magnitude as, or even identical to, those of the ion conductors that are impregnated into the solid [zeolite+binder]. The composition according to the invention consequently offers an excellent compromise between optimized mechanical properties (solid and flexible electrolyte) and maximum ion conductivity.

The composition of the present invention may be prepared by imbibing the system (zeolite crystals+polymeric binder) with the ion conductor, or by imbibing the zeolite crystals with the ion conductor, followed by adding the polymeric binder.

According to one embodiment, the process for preparing the composition according to the present invention involves:
a) mixing the zeolite crystals with at least one polymeric binder, in the solid state,
b) forming into the desired appearance and size,
c) heating and pressurizing the homogenized and formed assembly so as to soften the polymeric binder,
d) maintaining the temperature and pressure until there is cohesion between the zeolite crystals and the binder, and
e) cooling until the binder hardens.

The mixing in step a) may be performed according to any conventional technique well known to those skilled in the art for the mixing of solids. The forming into the desired appearance and size of step b) may be performed, for example, by extrusion or any other technique that is also well known to those skilled in the art.

The heating in step c) must be performed at a temperature that is sufficient to allow the polymeric binder to soften and adhere to the zeolite crystals. The heating temperature is typically about 5° C. to 10° C. above the melting point or softening temperature of the polymeric binder. The pressure applied depends on many factors including the amount of crystals relative to the binder, the size of the zeolite crystals, the nature of the binder, and others, and is typically between 10 MPa and 2000 MPa, generally between 100 MPa and 1500 MPa.

The imbibition step, whether it is performed on the zeolite crystals or on the article obtained after cooling in step e) of the process described above, may be performed by any means known per se, for example by partial or total, preferably total, immersion in the ion conductor, for a variable period of time depending on the nature and amount of the various components of the composition of the invention, and typically for a period of time that may range from a few minutes to a few hours.

The composition of the invention may be in several aspects and sizes, by way of example and for purely illustrative purposes, in the form of films, or agglomerates of various morphologies. For example, when the composition is used as an all-solid-state battery separator, the composition is in film form.

The composition of the present invention is thus in the form of a solid comprising zeolite crystals soaked with a solid electrolyte, said crystals being immobilized by means of a polymeric binder. The composition of the invention behaves like a reservoir comprising a liquid electrolyte, with no possible leakage of electrolyte. The flammability of the electrolyte is thereby greatly reduced.

The polymeric binder which immobilizes the zeolite crystals thus gives the solid composition of the invention mechanical strength and flexibility that are entirely suitable for use as a solid electrolyte, for example in lithium-ion type batteries.

The solid composition according to the invention thus behaves like a solid electrolyte in which the pores of the zeolites and the interstices between the crystals are filled, at least partially or totally, with a liquid ion conductor, the ions being able to circulate freely in said pores and interstices, without the solid electrolyte leaking any electrolyte.

The composition according to the invention, which is a solid electrolyte, demonstrates performance qualities at least equivalent to those of a liquid electrolyte in terms of ion conductivity and electrochemical stability. Specifically, it was observed that the composition of the invention offers entirely satisfactory and suitable electrochemical stability, in that it has very good resistance to oxidation and to reduction when an electrical voltage is applied. Thus, one of the additional advantages of the composition according to the invention is that it affords electrochemical performance at least equal to that of liquid electrolytes while at the same time improving the safety.

Moreover, the composition according to the invention surprisingly shows resistance to the growth of dendrites, typically lithium dendrites, which can be detrimental to the correct functioning of the batteries, by causing short circuits. Thus, the composition of the invention can be used not only in a battery with an anode made, for example, of graphite, graphite/silicon or silicon, but also with a metallic anode, for example lithium metal, which notably allows a gain in energy density relative to conventional Li-ion technologies.

On account of the numerous advantages afforded by the composition of the invention, the composition according to the invention can be used very advantageously as a solid electrolyte in many electrochemical devices, such as, by way of non-limiting examples, batteries, capacitors, electrochemical double-layer capacitors, membrane-electrode assemblies (MEAs) for fuel cells or electrochromic devices. More specifically, and as indicated previously, the solid electrolyte of the invention may be used as a separator, and/or in the cathode (catholyte), and/or in the anode (anolyte), in particular in a battery, more particularly a secondary battery, typically an all-solid-state battery, and even more particularly an all-solid-state lithium-ion battery.

According to yet another aspect, the invention relates to the use of the composition described previously as an all-solid-state battery separator. According to yet another aspect, the invention relates to a separator, notably for an Li-ion secondary battery comprising a composition according to the present invention. In a preferred embodiment, the composition according to the present invention constitutes the separator of an all-solid-state battery. The composition according to the present invention may also be used as an anolyte or as a catholyte in a battery, for example an Li-ion secondary battery, more particularly an all-solid-state battery.

According to one embodiment of the separator of the invention, it is in the form of a film. The separator advantageously has a thickness, measured with a Palmer micrometer, of between 5 μm and 500 μm, preferably between 5 μm and 100 μm, more preferably between 5 μm and 50 μm, and even more preferably between 5 μm and 20 μm.

Finally, the invention is directed towards providing rechargeable Li-ion batteries comprising such a separator.

The invention also relates to a battery comprising at least one composition comprising crystals of one or more zeolites and as defined previously, said battery being an all-solid-state battery, or an Li-ion secondary battery. In the battery according to the invention, said at least one composition comprising crystals of one or more zeolites and as defined previously composes the separator and/or the anolyte and/or the catholyte of said battery, preferably the separator.

### Characterization Techniques

The physical properties of the zeolites are evaluated by the methods known to those skilled in the art, the main ones of which are recalled below.

### Zeolite Crystal Particle Size:

The number-mean diameter of the zeolite crystals is estimated by observation under a scanning electron microscope (SEM). In order to estimate the size of the zeolite crystals on the samples, a set of images is taken at a magnification of at least 5000. The diameter of at least 200 crystals is then measured using dedicated software, for example the Smile View software published by LoGraMi. The accuracy is of the order of 3%.

### Chemical Analysis of the Zeolites—Si/Al Ratio and Degree of Exchange:

An elemental chemical analysis of the zeolite is performed according to the technique of chemical analysis by x-ray fluorescence as described in the standard NF EN ISO 12677:2011 on a wavelength-dispersive spectrometer (WDXRF), for example the Tiger S8 machine from the company Bruker.

X-ray fluorescence is a non-destructive spectral technique which exploits the photoluminescence of the atoms in the X-ray range, to establish the elemental composition of a sample. Excitation of the atoms, generally with an X-ray beam or by electron bombardment, generates specific radiations after return to the ground state of the atom. A measurement uncertainty of less than 0.4% by weight is conventionally obtained after calibration for each oxide.

Other methods of analysis are illustrated, for example, by the atomic absorption spectrometry (AAS) and inductively coupled plasma atomic emission spectrometry (ICP-AES) methods described in the standards NF EN ISO 21587-3 or NF EN ISO 21079-3 on a machine such as the Agilent 5110, for example.

After calibration for each oxide SiO₂ and Al₂O₃, and also for the various oxides (such as those originating from the exchangeable cations, for example sodium), a measurement uncertainty of less than 0.4% by weight is conventionally obtained. The ICP-AES method is particularly suitable for measuring the lithium content.

Thus, the elemental chemical analyses described above make it possible to check the Si/Al mole ratio of the zeolite used. In the description of the present invention, the measurement uncertainty of the Si/Al ratio is ±5%. The measurement of the Si/Al ratio of the zeolite present in the adsorbent material can also be performed by solid silicon nuclear magnetic resonance (NMR) spectroscopy.

The quality of the ion exchange is linked to the number of moles of the cation under consideration in the zeolite crystals after exchange. More precisely, the percentage of a cation relative to the number of exchangeable sites is estimated by evaluating the ratio between the equivalent number of moles of said cation (to reach electronic neutrality) and the total number of exchangeable sites which is equal to the total number of aluminium atoms present in the framework of the zeolite. The respective amounts of each of the cations are evaluated by chemical analysis of the corresponding cations.

The examples that follow illustrate the scope of the invention in a non-limiting manner.

### EXAMPLE 1: PREPARATION OF A SOLID ELECTROLYTE FOR AN LI-ION BATTERY SEPARATOR

A mixture is prepared containing 5% by mass of PVDF with a melting point below 175° C. (Kynar® from the company Arkema) and 95% by mass of lithium zeolite LiLSX (NaLSX crystals prepared according to EP2244976 and then exchanged with lithium by exchanging the sodium cations in a lithium chloride solution, according to conventional techniques). The number-mean diameter of the LiLSX crystals is 5.5 μm. The binder+zeolite crystals mixture is ground in a mortar and then compressed in a pelletizer at 3000 kg·cm⁻² and 160° C. for 15 minutes. A 250 μm thick film is then obtained, which is soaked at room temperature by immersing it in a solution of ion conductor A. The ion conductor A is composed of 80% by mass of succinonitrile and 20% by mass of LiTFSI (available from Gotion). The film is then drained and weighed so as to determine the gain in mass after imbibition, which is about 55%. The final solid electrolyte is then composed of LiLSX zeolite (61.7% by weight), PVDF (3.3% by weight) and ion conductor A (35% by weight). It is named SE1.

### Example 2: Preparation of a PEO-Based Solid Electrolyte for an Li-Ion Battery Separator

For comparative purposes, a PEO (poly(ethylene oxide))-based solid electrolyte is prepared, composed of 80% by mass of PEO and 20% by mass of LiTFSI. The PEO is dissolved in acetonitrile, and the LiTFSI is then added. The solution obtained is deposited by solvent casting onto a glass plate, and then dried under vacuum at 60° C. to evaporate off the acetonitrile. A self-supporting film, named SE2, is then obtained.

### Example 3: Measurement of the Conductivity of an all-Solid-State Separator

The conductivity (o) is evaluated by electrochemical impedance spectroscopy by placing the solid electrolyte (under an inert atmosphere) between the two gold electrodes of a leaktight conductivity cell and under an inert atmosphere (CESH, BioLogic). The results are presented in Table 1. The electrolyte SE1 has a much higher conductivity at 25° C. than the reference PEO (SE2).

TABLE 1

| | σ @ 25° C. |
|---|---|
| Solid electrolyte | (mS · cm⁻¹) |
| SE1 | 0.26 |
| SE2 | 0.00084 |

### EXAMPLE 4: MEASUREMENT OF THE THERMAL STABILITY OF AN ALL-SOLID-STATE SEPARATOR

The conductivity (o) is evaluated by electrochemical impedance spectroscopy by placing the solid electrolyte (under an inert atmosphere) between the two gold electrodes of a leaktight conductivity cell and under an inert atmosphere (CESH, BioLogic). The results are presented in Table 2. The electrolyte SE1 has a much higher conductivity at 25° C. than the reference PEO (SE2).

TABLE 2

| | σ₁ @ 25° C. | σ₂ @ 25° C. |
|---|---|---|
| Solid electrolyte | (mS · cm⁻¹) | (mS · cm⁻¹) |
| SE1 | 0.26 | 0.26 |
| SE2 | 0.00084 | 0.00084 |

### EXAMPLE 5: MEASUREMENT OF THE ELECTROCHEMICAL STABILITY OF AN ALL-SOLID-STATE SEPARATOR

The electrochemical stability of various solid electrolytes is evaluated by cyclic voltammetry at 60° C. by placing the solid electrolyte (under an inert atmosphere) in a button cell between a stainless steel electrode and a lithium metal electrode. Cyclic voltammetry is performed between 2 V and 6 V at 1 mV/s. The results are presented in Table 3. The electrolyte SE1 has a much higher electrochemical stability than the reference PEO (SE2).

TABLE 3

| | Electrochemical stability@ 60° C. |
|---|---|
| Solid electrolyte | (V) |
| SE1 | 4.7 |
| SE2 | 3.9 |

1. A composition comprising:
A/ crystals of one or more zeolites,
B/ at least one polymeric binder, the amount of the polymeric binder being between 0.5% and 20% by weight relative to the total weight of the zeolite crystals and of the binder, and
C/ at least one ion conductor comprising at least one lithium salt.

2. The composition according to claim 1, in wherein the zeolite crystals are crystals of one or more zeolites chosen from faujasites (FAU), MFI zeolites, chabazites (CHA), heulandites (HEU), Linde type A (LTA) zeolites, EMT zeolites, beta zeolites (BEA), mordenites (MOR) and mixtures thereof.

3. The composition according to claim 1, wherein the zeolite crystals are crystals of one or more zeolites chosen from type Y, X, MSX or LSX faujasite.

4. The composition according to claim 1, wherein the zeolite(s) crystals are crystals of one or more zeolites whose counter-cation is chosen from the hydronium ion, organic cations, alkali metal cations, alkaline-earth metal cations, transition metal cations, rare-earth metal cations, and also mixtures of two or more thereof.

5. The composition according to claim 1, wherein the zeolite crystals are crystals of one or more zeolites whose counter-cation is the lithium cation, optionally with the hydronium cation and/or one or more other alkali metal or alkaline-earth metal cations, and mixtures thereof.

6. The composition according to claim 1, wherein the size of the zeolite crystals is between 0.02 μm and 20.00 μm.

7. The composition according to claim 1, wherein the at least one polymeric binder is chosen from fluoropolymers, carboxymethylcelluloses, styrene-butadiene rubbers, polyacrylic acids and esters thereof, and polyimides.

8. The composition according to claim 1, wherein at least one polymeric binder is chosen from polyvinylidene fluoride, and copolymers of vinylidene fluoride with at least one comonomer that is compatible with vinylidene fluoride.

9. The composition according to claim 1, wherein the lithium salt is chosen from lithium bis(fluorosulfonyl)imide, lithium bis(trifluoromethanesulfonyl)imide, lithium 2-trifluoromethyl-4,5-dicyanoimidazole, lithium hexafluorophosphate, lithium tetrafluoroborate, lithium nitrate, lithium bis(oxalato) borate, and also mixtures of two or more thereof, in any proportions.

10. The composition according to claim 1, wherein the amount of ion conductor is generally between 5% and 400%, relative to the solid (zeolite crystals+polymeric binder(s)).

11. The composition according to claim 1, wherein the ion conductor comprises LiFSI, LiTFSI, or a mixture of LiFSI and LiTFSI, in combination with one or more solvents chosen from SN, DOL, DME, F1EC and EG4DME, optionally with one or more ionic liquids.

12. The composition according to claim 1, comprising:
A/ crystals of FAU-type zeolite(s),
B/ at least one fluorinated polymeric binder in an amount of between 0.5% and 20% by weight, relative to the total weight of the crystals of one or more zeolites and the binder, and
C/ at least one ion conductor comprising at least one lithium salt, at least one solvent chosen from SN, DOL, DME, F1EC and EG4DME, optionally with at least one ionic liquid.

13. Use of a composition according to claim 1, as a separator, and/or in the cathode (catholyte), and/or in the anode (anolyte).

14. Use according to claim 13, as a separator for an all-solid-state battery in the form of a film with a thickness of between 5 μm and 500 μm.
